(19) United States
(12) Patent Application Publication
(10) Pub. No.: US 2026/0251938 A1
(43) Pub. Date: Aug. 27, 2026

(54) LIQUID CRYSTAL ELEMENT

(71) Applicant: SHARP KABUSHIKI KAISHA, Sakai City (JP)

(72) Inventors: Hiroaki ASAGI, Sakai City (JP); Yuichi KAWAHIRA, Sakai City (JP); Kiyoshi MINOURA, Sakai-shi (JP); Yohsuke KANZAKI, Sakai City (JP); Naoki MAKITA, Sakai City (JP); Hiroshi MATSUKIZONO, Sakai City (JP); Kohhei TANAKA, Sakai City (JP); Tadayoshi MIYAMOTO, Sakai City (JP); Akira SAKAI, Sakai City (JP); Takashi SATOH, Sakai City (JP); Mikihiro NOMA, Sakai City (JP)

(21) Appl. No.: 19/539,574

(22) Filed: Feb. 13, 2026

(30) Foreign Application Priority Data
Feb. 21, 2025 (JP) 2025-026683

(51) Int. Cl. G02F 1/1343; G02F 1/1333

(52) U.S. Cl. CPC G02F 1/134318; G02F 1/133302; G02F 1/133368; G02F 1/134363; G02F 1/134372; G02F 1/13439

(57) ABSTRACT

A liquid crystal element includes a first substrate, a liquid crystal layer including liquid crystal molecules, and a second substrate provided with a first electrode and a second electrode for applying a transverse electrical field to the liquid crystal layer, wherein the second substrate includes an oxide semiconductor layer, the oxide semiconductor layer includes, in a plane, a first region and a second region having a resistance in a plane direction of the oxide semiconductor layer smaller than a resistance of the first region, and the second region constitutes the first electrode.

### CROSS-REFERENCE TO RELATED APPLICATIONS

This application claims the benefit of priority to Japanese Patent Application Number 2025-026683 filed on Feb. 21, 2025. The entire contents of the above-identified application are hereby incorporated by reference.

### BACKGROUND

### Technical Field

The disclosure described below relates to a liquid crystal element.

As an optical element (hereinafter, also referred to as a “liquid crystal element”) using a liquid crystal, a polarization modulation element and an electronic ND filter have been studied in recent years. Among them, a liquid crystal element using a liquid crystal mode (IPS mode/FFS mode) of a transverse electrical field is excellent in terms of a viewing angle and a wide color gamut, and studies thereof have been advanced (for example, refer to JP 2021-144115 A and JP 2022-030066 A).

### SUMMARY

(1) An embodiment of the disclosure is a liquid crystal element including a first substrate, a liquid crystal layer including liquid crystal molecules, and a second substrate provided with a first electrode and a second electrode configured to apply a transverse electrical field to the liquid crystal layer, wherein the second substrate includes an oxide semiconductor layer. The oxide semiconductor layer includes, in a plane, a first region and a second region having a resistance in a plane direction of the oxide semiconductor layer smaller than a resistance of the first region, and the second region constitutes the first electrode.

(2) In an embodiment of the disclosure, the liquid crystal element includes the configuration of (1) described above, and the second region further constitutes the second electrode.

(3) In an embodiment of the disclosure, the liquid crystal element includes the configuration of (1) or (2) described above, and the first region constitutes an electrode slit.

(4) In an embodiment of the disclosure, the liquid crystal element includes the configuration of (1), (2), or (3) described above, and the second region is an ion doping region of the oxide semiconductor layer.

(5) In an embodiment of the disclosure, the liquid crystal element includes the configuration of (1), (2), or (3) described above, and the second region is a plasma treatment region of the oxide semiconductor layer.

(6) In an embodiment of the disclosure, the liquid crystal element includes the configuration of (1), (2), or (3) described above, and the second region is a reduction treatment region of the oxide semiconductor layer.

(7) In an embodiment of the disclosure, the liquid crystal element includes the configuration of (1), (2), (3), (4), (5), or (6) described above, and the first electrode is constituted of a single layer of the oxide semiconductor layer.

(8) In an embodiment of the disclosure, the liquid crystal element includes the configuration of (1), (2), or (3) described above, and further includes a SiNx layer or a SiNO layer thinner than the oxide semiconductor layer, on the second region of the oxide semiconductor layer.

(9) In an embodiment of the disclosure, the liquid crystal element includes the configuration of (1), (2), (3), (4), (5), (6), (7), or (8) described above, and the oxide semiconductor layer includes IGZO, ITZO, IGO, or ITZGO.

(10) In an embodiment of the disclosure, the liquid crystal element includes the configuration of (1), (2), or (3) described above, and the oxide semiconductor layer includes a hybrid layer including a first oxide semiconductor and SiO₂ in the first region, and the oxide semiconductor layer includes the hybrid layer and a first oxide semiconductor layer in the second region, the first oxide semiconductor layer is thinner than the hybrid layer and includes the first oxide semiconductor with a higher purity than the hybrid layer, and the first oxide semiconductor is ITO, IZO, or AZO.

(11) In an embodiment of the disclosure, the liquid crystal element includes the configuration of (1), (2), (3), (4), (5), (6), (7), (8), (9), or (10) described above, and the first region has a resistance of more than 1×10⁶Ω/□ in a plane direction of the oxide semiconductor layer, and the second region has a resistance of 1×10⁶Ω/□ or less in both the plane direction and a film thickness direction of the oxide semiconductor layer.

(12) In an embodiment of the disclosure, the liquid crystal element includes the configuration of (1), (2), (3), (4), (5), (6), (7), (8), (9), (10), or (11) described above, and a threshold voltage of the first region of the oxide semiconductor layer is higher than a drive voltage of the liquid crystal layer.

According to the disclosure, it is possible to provide a liquid crystal element that can prevent diffraction of light and a decrease in contrast while utilizing the liquid crystal mode of the transverse electrical field.

### BRIEF DESCRIPTION OF DRAWINGS

The disclosure will be described with reference to the accompanying drawings, wherein like numbers reference like elements.

FIG. 1 is a cross-sectional view schematically illustrating a main configuration of a liquid crystal element of a first embodiment.

FIG. 2 is a cross-sectional view of a second substrate for describing a method of forming a high-resistance region and a low-resistance region of the first embodiment.

FIG. 3 is a plan view illustrating patterns of the high-resistance region and the low-resistance region of the first embodiment.

FIG. 4A is a cross-sectional view schematically illustrating a flow of a conductorization treatment of an oxide semiconductor layer of the first embodiment.

FIG. 4B is a cross-sectional view schematically illustrating the flow of the conductorization treatment of the oxide semiconductor layer of the first embodiment.

FIG. 4C is a cross-sectional view schematically illustrating the flow of the conductorization treatment of the oxide semiconductor layer of the first embodiment.

FIG. 4D is a cross-sectional view schematically illustrating the flow of the conductorization treatment of the oxide semiconductor layer of the first embodiment.

FIG. 5 is a cross-sectional view of a second substrate for describing an arrangement of a high-resistance region and a low-resistance region of a second embodiment.

FIG. 6 is a plan view illustrating patterns of the high-resistance region and the low-resistance region of the second embodiment.

FIG. 7A is a cross-sectional view schematically illustrating an example of a flow of a conductorization treatment of an oxide semiconductor layer of a third embodiment.

FIG. 7B is a cross-sectional view schematically illustrating an example of the flow of the conductorization treatment of the oxide semiconductor layer of the third embodiment.

FIG. 8A is a cross-sectional view schematically illustrating another example of the flow of the conductorization treatment of the oxide semiconductor layer of the third embodiment.

FIG. 8B is a cross-sectional view schematically illustrating another example of the flow of the conductorization treatment of the oxide semiconductor layer of the third embodiment.

FIG. 9A is a cross-sectional view schematically illustrating the flow of the conductorization treatment of the oxide semiconductor layer of a fourth embodiment.

FIG. 9B is a cross-sectional view schematically illustrating the flow of the conductorization treatment of the oxide semiconductor layer of the fourth embodiment.

FIG. 9C is a cross-sectional view schematically illustrating the flow of the conductorization treatment of the oxide semiconductor layer of the fourth embodiment.

FIG. 9D is a cross-sectional view schematically illustrating the flow of the conductorization treatment of the oxide semiconductor layer of the fourth embodiment.

FIG. 10A is a cross-sectional view schematically illustrating the flow of the conductorization treatment of the oxide semiconductor layer of a fifth embodiment.

FIG. 10B is a cross-sectional view schematically illustrating the flow of the conductorization treatment of the oxide semiconductor layer of the fifth embodiment.

FIG. 10C is a cross-sectional view schematically illustrating the flow of the conductorization treatment of the oxide semiconductor layer of the fifth embodiment.

FIG. 11A is a cross-sectional view schematically illustrating the flow of the conductorization treatment of the oxide semiconductor layer of a sixth embodiment.

FIG. 11B is a cross-sectional view schematically illustrating the flow of the conductorization treatment of the oxide semiconductor layer of the sixth embodiment.

FIG. 12A is a cross-sectional view schematically illustrating another example of the flow of the conductorization treatment of the oxide semiconductor layer of the sixth embodiment.

FIG. 12B is a cross-sectional view schematically illustrating another example of the flow of the conductorization treatment of the oxide semiconductor layer of the sixth embodiment.

FIG. 13 is a cross-sectional view schematically illustrating an example of a configuration of a second substrate of a liquid crystal element of a seventh embodiment.

FIG. 14 is a cross-sectional view schematically illustrating another example of the configuration of the second substrate of the liquid crystal element of the seventh embodiment.

FIG. 15 is a cross-sectional view schematically illustrating an example of a liquid crystal alignment in a normal FFS mode liquid crystal element.

FIG. 16 is a cross-sectional view schematically illustrating a liquid crystal alignment in a liquid crystal element of an eighth embodiment.

FIG. 17 is a schematic cross-sectional view illustrating a configuration of a liquid crystal element according to Comparative Example 1.

FIG. 18 is a cross-sectional view for describing that diffraction of light occurs in a known FFS mode electrode structure.

FIG. 19 is a contour diagram showing a contrast corresponding to an azimuth and a polar angle of a known FFS mode liquid crystal element.

FIG. 20 is a graph showing a relationship between the size of a step formed by a known FFS mode electrode and an oblique contrast at the azimuth of 45 degrees and the polar angle of 60 degrees.

### DESCRIPTION OF EMBODIMENTS

The liquid crystal mode of the transverse electrical field has a problem that incident light is diffracted. As a specific example, when a light source such as light of a smartphone is observed through a panel, a rainbow light beam is generated due to diffraction. A known FFS mode substrate or a known IPS mode substrate has a physical/optical periodic structure (for example, a structure in which a plurality of electrode slits extending in a predetermined direction are formed in an electrode provided on the substrate at regular intervals in a direction intersecting the predetermined direction), and thus diffraction of light occurs according to the periodic structure, and a multiple image is generated. In addition, diffraction has a property that a diffraction angle differs depending on a wavelength of light, and thus the multiple image is colored in rainbow colors. As a result, the rainbow light beam as described above is observed. In the case of the FFS mode, diffraction occurs in a vertical direction with respect to the extending direction of the electrode slits, and thus, a phenomenon occurs in which the light beam spreads in one direction.

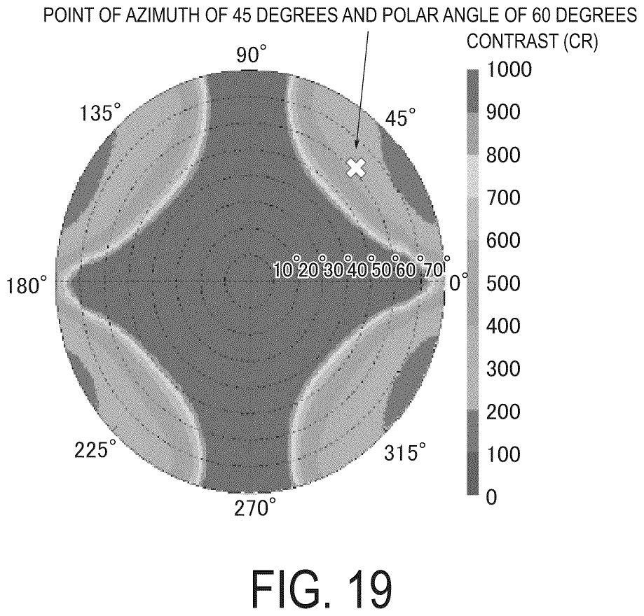

Originally, a liquid crystal display panel as a liquid crystal element has a low contrast in oblique viewing as compared with front viewing due to viewing angle dependency of a polarizer. The FFS mode is a liquid crystal mode generally having a good viewing angle (relatively small viewing angle dependency of contrast), but there is room for improvement in contrast in an oblique direction (hereinafter, also referred to as “oblique CR”), and particularly, a decrease in oblique CR is large at an azimuth of 45 degrees. FIG. 19 is a contour diagram showing the contrast corresponding to the azimuth and a polar angle of a known FFS mode liquid crystal element. As shown in FIG. 19, the contrast is particularly small at a point of the azimuth of 45 degrees and the polar angle of 60 degrees indicated by an x mark in the drawing.

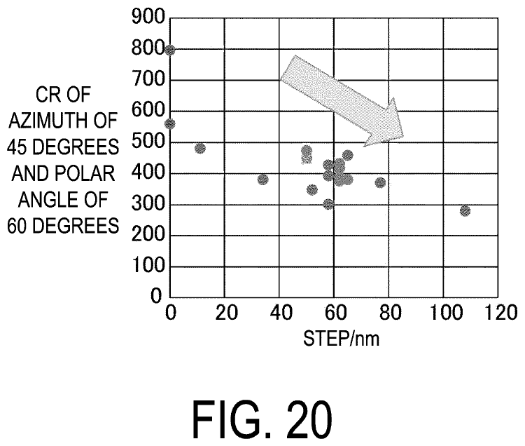

FIG. 20 is a graph showing a relationship between the size of a step formed by a known FFS mode electrode and an oblique contrast at the azimuth of 45 degrees and the polar angle of 60 degrees. As a result of the study by the present inventors, it was found that, in the case of the FFS mode, the oblique CR is correlated with the step due to unevenness of the FFS mode electrode, and as shown in FIG. 20, the larger the step, the larger the decrease in the oblique CR. This is considered to be because the step causes light scattering and liquid crystal alignment defects, leading to a decrease in contrast.

JP 2021-144115 A and JP 2022-030066 A disclose that the unevenness caused by an FFS mode comb teeth electrode is flattened by a flattening film such as a high refractive index inorganic film or a high refractive index resin film. However, the flattening cannot be physically and completely performed and a refractive index of the electrode cannot be optically and completely matched with a refractive index of the flattening film, and thus the occurrence of the diffraction light cannot be prevented. Thus, the effect of improving the contrast is not sufficient, and there is room for further improvement.

The disclosure has been made in view of the above circumstances, and an object thereof is to provide a liquid crystal element that can prevent diffraction of light and a decrease in contrast while utilizing the liquid crystal mode of the transverse electrical field.

Embodiments of a liquid crystal element according to the disclosure will be described below with reference to the drawings. In the drawings, identical or equivalent elements are given an identical reference sign, and redundant descriptions thereof may be omitted.

### First Embodiment

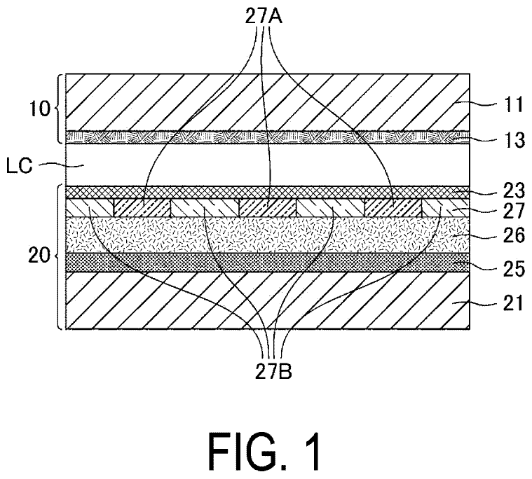

FIG. 1 is a cross-sectional view schematically illustrating a main configuration of a liquid crystal element of a first embodiment. As illustrated in FIG. 1, the liquid crystal element of the first embodiment is a liquid crystal element of a fringe field switching (FFS) mode, and includes a first substrate 10, a liquid crystal layer LC containing liquid crystal molecules, and a second substrate 20 provided with a common electrode 25 (one of a first electrode and a second electrode) and a pixel electrode (the other of the first electrode and the second electrode) that apply a transverse electrical field to the liquid crystal layer LC. The first substrate includes a glass substrate 11 and an alignment film 13. The second substrate 20 includes a glass substrate 21, a common electrode 25, an interlayer insulating film 26, an oxide semiconductor layer 27, and an alignment film 23. The oxide semiconductor layer 27 includes a high-resistance region 27B (first region) and a low-resistance region 27A (second region) in the plane, and the low-resistance region 27A having a resistance in the plane direction of the oxide semiconductor layer 27 smaller than a resistance of the high-resistance region 27B constitutes the first electrode (pixel electrode in the present embodiment). The high-resistance region 27B preferably has a resistance of more than 1×10⁶Ω/□ in the plane direction of the oxide semiconductor layer 27. The low-resistance region 27A preferably has a resistance of 1×10⁶Ω/□ or less in both the plane direction and a film thickness direction of the oxide semiconductor layer 27. The high-resistance region 27B may have a resistance of more than 1×10⁶Ω/□ or equal to 1×10⁶Ω/□ or less in the film thickness direction of the oxide semiconductor layer 27. The second substrate 20 preferably includes a wiring line and an electrode for applying a voltage to the common electrode 25 and the pixel electrode (low-resistance region 27A), and for example, a TFT array substrate may be used. A voltage common to a plurality of pixels is applied to the common electrode 25, and a voltage (signal) different for each pixel is applied to the pixel electrode (low-resistance region 27A). In the FFS mode, among the common electrode 25 and the pixel electrode (low-resistance region 27A). The electrode closer to the liquid crystal layer is provided with an electrode slit (for example, an opening extending in a predetermined direction), and a transverse electrical field (also referred to as an “oblique electrical field”) corresponding to a difference in a voltage between the common electrode 25 and the pixel electrode (low-resistance region 27A) is applied to the liquid crystal layer LC through the electrode slit. The electrode slit is not limited to the opening, and may be any regions where no electrode (conductive portion) is formed. In the first embodiment, the high-resistance region 27B of the oxide semiconductor layer 27 constitutes the electrode slit. In the first embodiment, configurations of the second substrate 20 other than the oxide semiconductor layer 27 may be the same as those of a general FFS mode liquid crystal element, and thus the oxide semiconductor layer 27 of the second substrate 20 will be described in detail below.

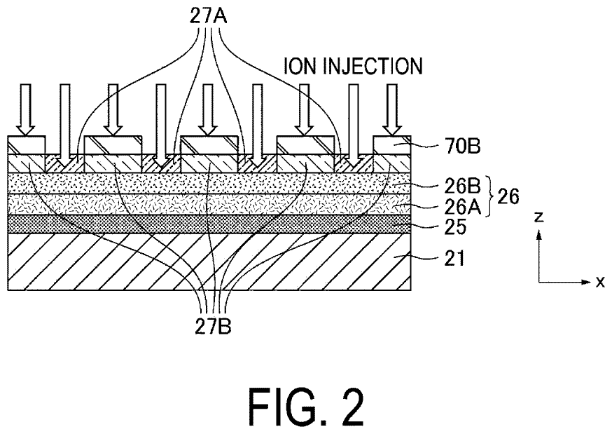

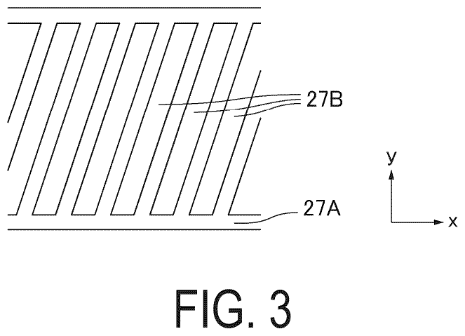

FIG. 2 is a cross-sectional view of the second substrate for describing a method of forming the high-resistance region and the low-resistance region of the first embodiment. FIG. 3 is a plan view illustrating patterns of the high-resistance region and the low-resistance region of the first embodiment.

In the first embodiment, the low-resistance region 27A serving as an FFS mode pixel electrode is a region where the oxide semiconductor layer 27 is subjected to the conductorization treatment (here, ion doping (ion injection)), and the high-resistance region 27B serving as an FFS mode electrode slit is a region where the oxide semiconductor layer 27 is not subjected to the conductorization treatment (here, ion doping (ion injection)). The pixel electrode is constituted of a single layer of the oxide semiconductor layer 27. As illustrated in FIGS. 2 and 3, after a protection resist 70B is layered on a portion to be the high-resistance region 27B of the oxide semiconductor layer 27, ion doping is performed on the oxide semiconductor layer 27 and a part of the oxide semiconductor is subjected to the conductorization treatment, thereby forming the low-resistance region 27A. The patterns (planar shapes) of the high-resistance region 27B and the low-resistance region 27A can be formed into a desired shape by adjusting the pattern of the protection resist 70B by using photolithography or the like. In the example of FIG. 3, in a plan view, a plurality of the high-resistance regions 27B (regions constituting the electrode slits) are formed so as to extend in a predetermined direction and to be arranged in parallel at regular intervals in a direction intersecting the predetermined direction, and the low-resistance region 27A (region constituting the pixel electrode) is formed in portions other than the plurality of high-resistance regions 27B in the oxide semiconductor layer 27. That is, the low-resistance region 27A includes, in a plan view, an outer peripheral portion that may include an outer edge of the oxide semiconductor layer 27, and a plurality of line-shaped electrodes that extend from the outer peripheral portion in the predetermined direction and are arranged in parallel at regular intervals in a direction intersecting the predetermined direction. As the interlayer insulating film 26, for example, a layered body of a silicon nitride (SiNx) film 26A and a silicon-oxide (SiO₂) film 26B is used.

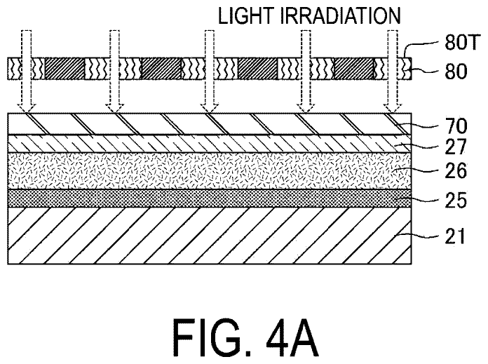

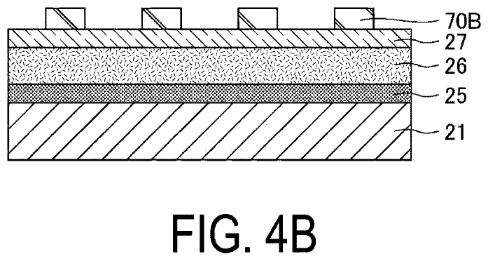

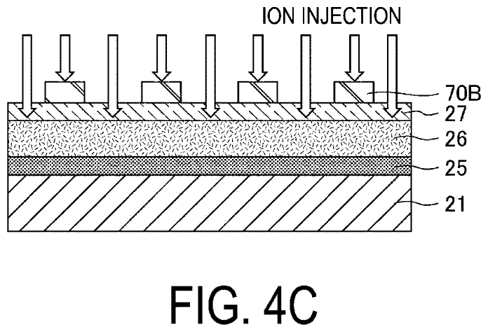

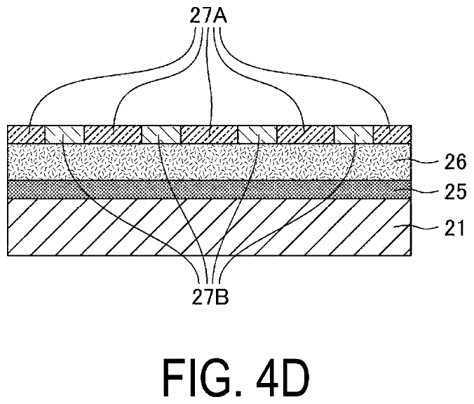

FIGS. 4A, 4B, 4C, and 4D are cross-sectional views each schematically illustrating the flow of the conductorization treatment of the oxide semiconductor layer 27 of the first embodiment. As illustrated in FIGS. 4A, 4B, 4C, and 4D, the second substrate 20 can be formed by a process performed in the order of the following steps (1) to (7).

(1) ITO of the common electrode 25 is formed on the glass substrate 21 by sputtering to have a film thickness of, for example, 50 nm.

(2) As the interlayer insulating film 26, the SiNx film 26A and the SiO₂ film 26B are formed in this order by CVD to have the film thicknesses of, for example, 160 nm and 50 nm, respectively.

(3) The oxide semiconductor layer 27 such as IGZO is formed by sputtering to have a film thickness of, for example, 50 nm.

(4) After a photosensitive resin layer 70 is formed, the photosensitive resin layer 70 is irradiated with light through a light transmitting portion 80T of a photomask 80 (see FIG. 4A). The light transmitting portion 80T has a pattern corresponding to the low-resistance region 27A.

(5) The photosensitive resin layer 70 is developed to form the protection resist 70B. The protection resist 70B is patterned so as to remain only in the high-resistance region 27B that has not been irradiated with light (see FIG. 4B).

(6) Boron ions (B⁺ ions) are injected into the entire surface from above the glass substrate 21 at, for example, an acceleration voltage of 20 kV and a dose amount of 1×10¹³ ions/cm² (see FIG. 4C).

(7) The protection resist 70B is removed with a peeling solution (see FIG. 4D).

A part of the oxide semiconductor layer 27 (a portion corresponding to the low-resistance region 27A) is made conductive by the ion doping in the step (6). A principle of conductorization is considered to be that an oxygen defect level in the oxide semiconductor is increased by collision of B⁺ ions to be doped, and thus a carrier density in the film is increased and the resistance is decreased. Such conductorization is different from the case of carrier generation by impurities in a general Si semiconductor, and thus activation annealing performed after the ion doping of the Si semiconductor need not be performed.

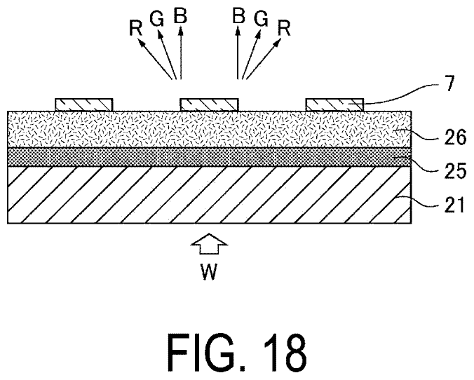

FIG. 18 is a cross-sectional view for describing that diffraction of light occurs in a known FFS mode electrode structure. A known FFS mode electrode 7 is layered on the flat interlayer insulating film 26 in a periodic pattern in a plan view, and unevenness is generated by the thickness thereof. When white light W is incident from the glass substrate 21 side toward the liquid crystal layer LC, diffraction of light occurs due to the unevenness of the FFS mode electrode 7, and a multiple image is generated. Further, diffraction has a property that a diffraction angle differs depending on a wavelength of light, and thus the light is separated into red (R), green (G), and blue (B) light, and the multiple image is colored in rainbow colors.

In contrast, the conductorization by the ion doping in the step (6) can perform electrical patterning of the high-resistance region and the low-resistance region in the plane while maintaining the physical shape flat. At this time, physical unevenness is not generated and the refractive index does not change, and thus the high-resistance region and the low-resistance region also have no optical difference from each other in phase and are flat. Thus, diffraction and scattering of incident light do not occur, and a decrease in contrast can be prevented.

A method of the ion doping described above is not particularly limited, and a shower type, a mass separation type, or the like can be used. As the ions to be implanted, hydrogen ions may be injected in addition to boron ions (B⁺). This can be achieved by injecting divalent boron (BH⁺, B₂H₅⁺, or the like). Instead of divalent boron, for example, divalent phosphorus (PH⁺) may be used. The addition of hydrogen ions to the ions to be injected stabilizes the reduction in the resistance of the oxide semiconductor (for example, IGZO) layer 27.

The sheet resistance (surface resistance) of the low-resistance region 27A is, for example, from 10² Ω/□ to 10⁶Ω/□. The sheet resistance of the high-resistance region 27B is, for example, from 10⁷Ω/□ to 10¹⁴Ω/□.

The following materials are used for the constituent members of the second substrate 20.

As the common electrode 25, a low resistance and transparent material such as ITO or IZO is suitably used. The material of the oxide semiconductor layer 27 is not particularly limited as long as the material has a high resistance in the undoped region and a low resistance in the doped region, and ITZO, IGO, ITZGO, or the like may be used in addition to IGZO. In the names of oxide semiconductors in the disclosure, “I” refers to indium (In), “G” refers to gallium (Ga), “Z” refers to zinc (Zn), “O” refers to oxygen, “T” refers to tin, and “A” refers to aluminum (Al).

As the interlayer insulating film 26, the layered body of the SiNx film 26A and the SiO₂ film 26B may be used as described above, or a single layer film of SiNx, SiO₂, SiON, or the like, or a layered film thereof may be used. The interlayer insulating film 26 is preferably selected from a combination that is less likely to be affected by interference by optical simulation.

In the case where an SiNx single layer is used as the interlayer insulating film 26, when the interlayer insulating film 26 is in contact with IGZO of the oxide semiconductor layer 27, the entire surface of IGZO is reduced in a subsequent thermal process to be made conductive, and thus, the layer in contact with IGZO is desirably SiO₂.

In addition, when SiO₂ is formed directly on ITO of the common electrode 25, there is a concern that the film may be peeled off, and thus SiNx is preferably formed on ITO.

Thus, a layered structure of the glass substrate 21/ITO (common electrode 25)/SiNx film 26A (interlayer insulating film 26)/SiO₂ film 26B (interlayer insulating film 26)/IGZO (oxide semiconductor layer 27) is suitably used.

The liquid crystal element is prepared using the prepared second substrate 20 through the steps of applying the alignment film 23, drawing a seal, dropping the liquid crystal, curing the seal, and attaching a polarizer. In Example 1 described later, the liquid crystal element of the first embodiment was actually prepared and subjected to an evaluation test.

### Second Embodiment

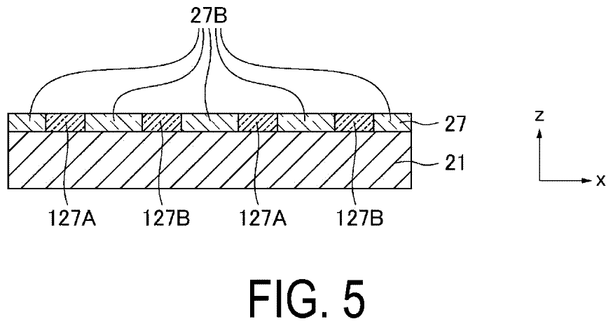

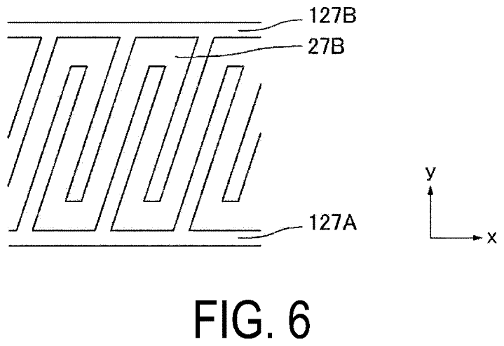

FIG. 5 is a cross-sectional view of the second substrate for describing an arrangement of the high-resistance region and the low-resistance region of a second embodiment. FIG. 6 is a plan view illustrating patterns of the high-resistance region and the low-resistance region of the second embodiment. As illustrated in FIGS. 5 and 6, the second embodiment is the same as the first embodiment except that an in-plane switching (IPS) mode electrode structure is adopted as the structure of the second substrate 20 instead of the FFS mode electrode structure of the first embodiment. That is, the liquid crystal element of the second embodiment is an IPS mode liquid crystal element.

In the second embodiment, the oxide semiconductor layer 27 includes the high-resistance region 27B and low-resistance regions 127A and 127B in the plane, the low-resistance region 127A constitutes the pixel electrode, and the low-resistance region 127B constitutes the common electrode. That is, the low-resistance regions 127A and 127B of the oxide semiconductor layer 27 constitute not only the pixel electrode but also the common electrode. The high-resistance region 27B of the oxide semiconductor layer 27 constitutes the electrode slit in the same manner as in the case of the FFS mode. In the example of FIG. 6, in a plan view, the low-resistance region 127A (region constituting the pixel electrode) and the low-resistance region 127B (region constituting common electrode) are formed so as to constitute a pair of comb shape electrodes, and the high-resistance region 27B (region constituting the electrode slit) is formed in portions other than the low-resistance regions 127A and the 127B in the oxide semiconductor layer 27. That is, each of the low-resistance region 127A and 127B includes a trunk portion that may include the outer edge of the oxide semiconductor layer 27 and a plurality of branch portions that extend from the trunk portion in a predetermined direction and are arranged in parallel at regular intervals in a direction intersecting the predetermined direction in a plan view, and the plurality of branch portions of the low-resistance region 127A and the plurality of branch portions of the low-resistance region 127B are alternately arranged in the direction intersecting the predetermined direction.

In the IPS mode, the interlayer insulating film 26 including the SiNx film 26A and the SiO₂ film 26B can be omitted, and the coloring and a decrease in transmittance each due to the multilayer film interference can be reduced. As a result, a liquid crystal element having excellent transmittance and color reproducibility can be obtained.

### Third Embodiment

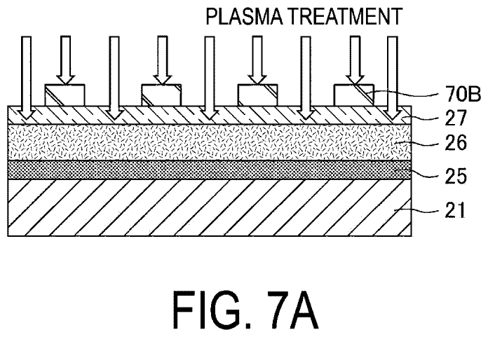

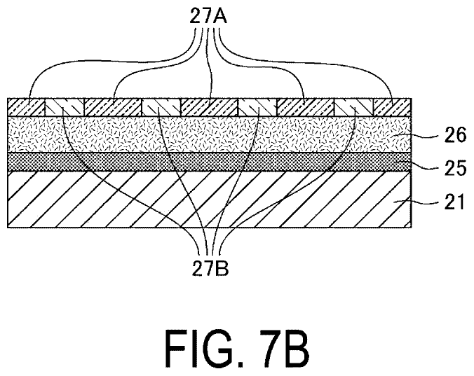

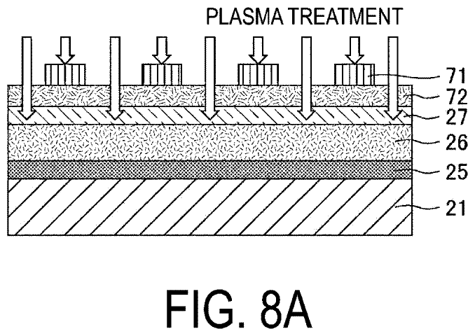

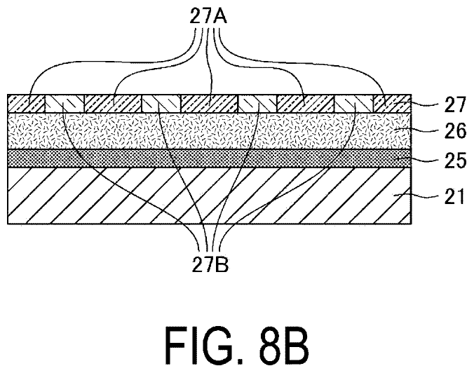

FIGS. 7A and 7B are cross-sectional views each schematically illustrating an example of a flow of a conductorization treatment of an oxide semiconductor layer of a third embodiment, and FIGS. 8A and 8B are cross-sectional views each schematically illustrating another example of the flow of the conductorization treatment of the oxide semiconductor layer of the third embodiment.

In the third embodiment, the low-resistance region 27A serving as the FFS mode pixel electrode is a plasma treatment region of the oxide semiconductor layer 27, and the high-resistance region 27B serving as the FFS mode electrode slit is a region where the oxide semiconductor layer 27 is not subjected to the plasma treatment. The third embodiment is the same as the first embodiment except that the plasma treatment is adopted as the conductorization treatment (resistance reduction treatment) of the oxide semiconductor layer 27 instead of the ion doping of the first embodiment. In the plasma treatment, a protection material is disposed on a region to be the high-resistance region 27B of the oxide semiconductor layer 27. As the protection material described above, the protection resist 70B may be used as illustrated in FIG. 7A, or a metal layer 71 may be used as illustrated in FIG. 8A. The material of the metal layer 71 is not particularly limited, and for example, titanium (Ti) may be used. When the protection resist 70B is used as the protection material, the protection resist 70B may be formed directly on the oxide semiconductor layer 27, but when the metal (titanium) layer 71 is used as the protection material, an SiO₂ film 72 is preferably provided between the metal layer 71 and the oxide semiconductor (IGZO) layer 27. By disposing the SiO₂ film 72 between the metal layer 71 and the oxide semiconductor (IGZO) layer 27, the IGZO can be prevented from being made conductive due to being in contact with the metal, and thus the region to be protected (desired to be the high-resistance region) can be prevented from being made conductive.

By performing the plasma treatment on a surface layer portion of the oxide semiconductor layer 27 (for example, the IGZO layer), the surface layer portion exhibits a property of a conductor. The plasma treatment can be performed using a gas such as a mixed gas of CF₄ and O₂, HCl, a mixed gas of HCl and O₂, a mixed gas of SF₆ and O₂, N₂, O₂, CH₄, or NH₃. By using the plasma treatment, similarly to the conductorization treatment by the ion doping of the first embodiment, an electrode can be formed in which diffraction and scattering of incident light do not occur and a decrease in contrast can be prevented. This plasma treatment may be combined with a heat treatment.

The conductorization treatment by the ion doping of the first embodiment uses an ion doping apparatus generally used in a manufacturing method for a polysilicon semiconductor, and thus is suitable for small to medium sized manufacturing lines. On the other hand, the plasma treatment of the present embodiment is a simple method that can be achieved even in a large amorphous silicon semiconductor manufacturing line, and thus, when a plurality of the liquid crystal elements are simultaneously manufactured using a large mother substrate, an effect of improving productivity is obtained.

### Fourth Embodiment

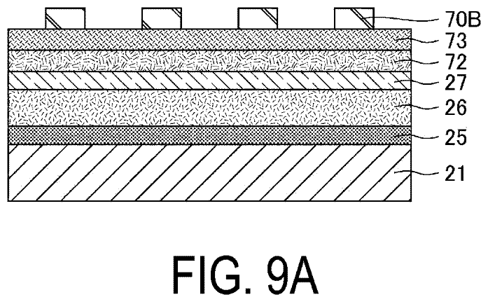

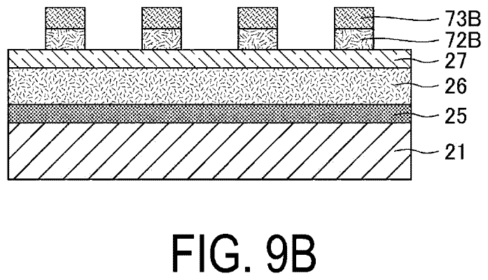

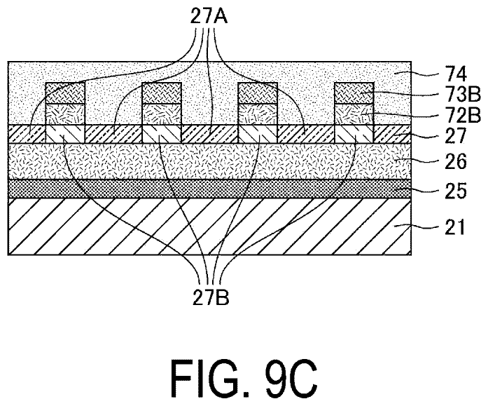

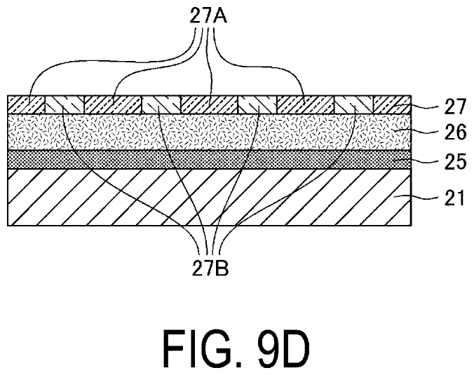

FIGS. 9A, 9B, 9C, and 9D are cross-sectional views each schematically illustrating the flow of the conductorization treatment of the oxide semiconductor layer of a fourth embodiment.

In the fourth embodiment, the low-resistance region 27A serving as the FFS mode pixel electrode is a reduction treatment region of the oxide semiconductor layer 27 (IGZO layer), and the high-resistance region 27B serving as the FFS mode electrode slit is a region where the oxide semiconductor layer 27 (IGZO layer) is not subjected to the reduction treatment. As illustrated in FIGS. 9A, 9B, 9C, and 9D, the fourth embodiment is the same as the first embodiment except that the reduction treatment with SiNx is adopted as the conductorization treatment of the oxide semiconductor layer 27 instead of the ion doping of the first embodiment. IGZO can be reduced to be made conductive by being brought into contact with SiNx. Examples of the oxide semiconductor to be reduced with SiNx also include ITZO, IGO, and ITZGO. Instead of the reduction treatment with SiNx, a reduction treatment with SiNO may be performed. Ti and SiO₂ are used to separately form the low-resistance region 27A and the high-resistance region 27B.

The conductorization treatment described above is implemented by, for example, a process of the following steps (1) to (8) performed in this order.

(1) ITO of the common electrode 25 is formed on the glass substrate 21 by sputtering to have a film thickness of, for example, 50 nm.

(2) As the interlayer insulating film 26, the SiNx film 26A and the SiO₂ film 26B are formed in this order by CVD to have the film thicknesses of, for example, 160 nm and 50 nm, respectively.

(3) The oxide semiconductor layer 27 (IGZO layer) is formed by sputtering to have a film thickness of, for example, 50 nm.

(4) The SiO₂ film 72 having a thickness of about 50 nm and a Ti film 73 having a thickness of about 100 nm are formed by CVD and sputtering, respectively.

(5) The protection resist 70B is patterned so as to remain only on the high-resistance region 27B, and the Ti film 73 and the SiO₂ film 72 are etched by CF₄-based dry etching to form a Ti pattern film 73B and an SiO₂ pattern film 72B.

(6) The protection resist 70B is removed with the peeling solution.

(7) An SiNx film 74 having a thickness of about 100 nm is formed by plasma CVD. A temperature during CVD is, for example, from 200° C. to 300° C. Only IGZO of the portion in contact with the SiNx film 74 is made conductive.

(8) The SiNx film 74, the Ti pattern film 73B, and the SiO₂ pattern film 72B, which are no longer required, are removed by the CF₄-based dry etching, and the flat surface of the oxide semiconductor layer 27 (IGZO layer) is exposed.

### Fifth Embodiment

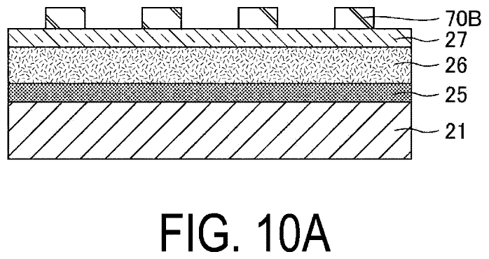

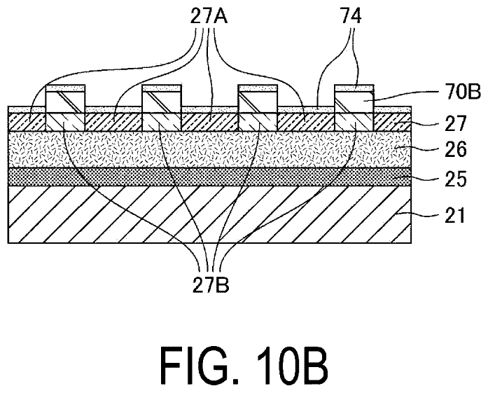

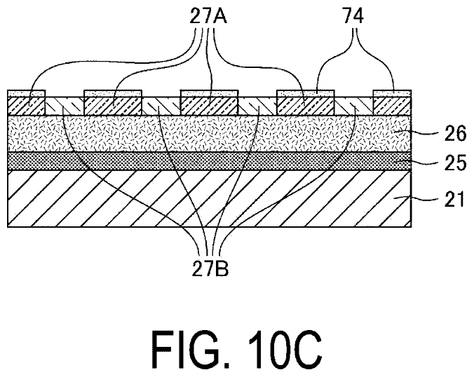

FIGS. 10A, 10B, and 10C are cross-sectional views each schematically illustrating the flow of the conductorization treatment of the oxide semiconductor layer of a fifth embodiment.

In the fifth embodiment, the low-resistance region 27A serving as the FFS mode pixel electrode is a reduction treatment region of the oxide semiconductor layer 27 (IGZO layer), and the high-resistance region 27B serving as the FFS mode electrode slit is a region where the oxide semiconductor layer 27 (IGZO layer) is not subjected to the reduction treatment. The SiNx film 74, which is thinner than the oxide semiconductor layer 27, is included on the low-resistance region 27A (on the liquid crystal layer side of the low-resistance region) of the oxide semiconductor layer 27. The SiNx film 74 is used for the reduction treatment of the oxide semiconductor layer 27, and is formed to have the thickness of, for example, 10 nm or less, and preferably 5 nm or less so that a step is not generated at the boundary between the low-resistance region 27A and the high-resistance region 27B. As illustrated in FIGS. 10A, 10B, and 10C, the fifth embodiment is the same as the fourth embodiment in that the reduction treatment with SiNx is adopted as the conductorization treatment of the oxide semiconductor layer 27, but is different from the fourth embodiment in that a lift-off resist is used to separately form the low-resistance region 27A and the high-resistance region 27B.

By removing the protection resist 70B by the lift-off, the oxide semiconductor layer 27 (IGZO layer) having a distribution of the low-resistance region 27A and the high-resistance region 27B can be formed. In the present embodiment, the SiNx film 74 of an ultrathin film remains in the portion (the low-resistance region 27A) where the protection resist 70B is not present. Examples of the oxide semiconductor to be reduced with SiNx also include ITZO, IGO, and ITZGO. Instead of the reduction treatment with SiNx, a reduction treatment with SiNO may be performed. In this case, the SiNO film of an ultrathin film remains in the portion (the low-resistance region 27A) where the protection resist 70B is not present.

The conductorization treatment described above is implemented by, for example, a process of the following steps (1) to (6) performed in this order.

(1) ITO of the common electrode 25 is formed on the glass substrate 21 by sputtering to have a film thickness of, for example, 50 nm.

(2) As the interlayer insulating film 26, the SiNx film 26A and the SiO₂ film 26B are formed in this order by CVD to have the film thicknesses of, for example, 160 nm and 50 nm, respectively.

(3) The oxide semiconductor layer 27 (IGZO layer) is formed by sputtering to have a film thickness of, for example, 50 nm.

(4) The protection resist 70B is patterned so as to remain only on the high-resistance region 27B.

(5) The SiNx film 74 having a thickness of about 5 nm is formed by plasma CVD. A temperature during CVD is, for example, from 200° C. to 300° C. Only IGZO of the portion in contact with SiNx is made conductive.

(6) The protection resist 70B is removed with the peeling solution (lift-off).

### Sixth Embodiment

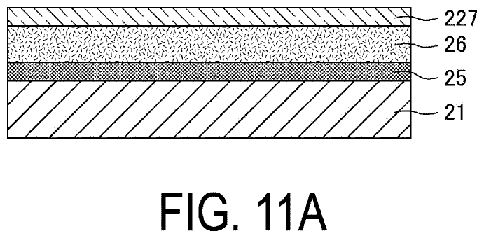

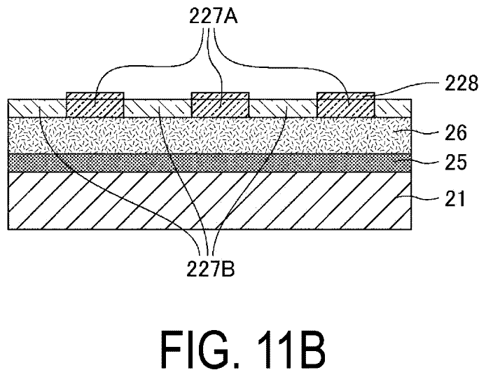

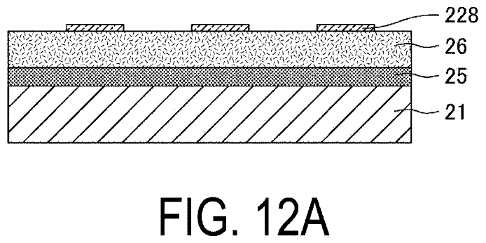

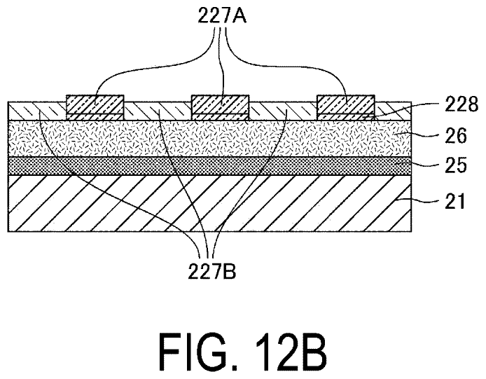

FIGS. 11A and 11B are cross-sectional views each schematically illustrating an example of a flow of a conductorization treatment of an oxide semiconductor layer of a sixth embodiment, and FIGS. 12A and 12B are cross-sectional views each schematically illustrating another example of the flow of the conductorization treatment of the oxide semiconductor layer of the sixth embodiment.

In the sixth embodiment, a low-resistance region 227A serving as the FFS mode pixel electrode is a region including a hybrid layer 227 containing ITO and SiO₂ and an ITO layer 228 that is thinner than the hybrid layer 227 and contains ITO with a higher purity, and a high-resistance region 227B serving as the FFS mode electrode slit is a region including only the hybrid layer 227 containing ITO and SiO₂. The ITO layer 228 described above is provided for conductorization, and is formed to have the thickness of, for example, 10 nm or less, and preferably 5 nm or less so that a step is not generated at the boundary between the low-resistance region 227A and the high-resistance region 227B and is referred to as an ultrathin film ITO.

The sixth embodiment is the same as the first embodiment except that high-resistance ITO that is the hybrid layer 227 of ITO and SiO₂, is used as the oxide semiconductor layer, and the ultrathin film ITO 228 is layered to be made conductive.

The hybrid layer 227 is constituted of a columnar texture of ITO and SiO₂. Thus, the resistance in the plane direction is high, but the resistance in the film thickness direction is low. When the ultrathin film ITO 228 is layered on the hybrid layer 227, a gap of roughness of the columnar texture is electrically bridged. Accordingly, the resistance of the hybrid layer 227 (high-resistance ITO) is lowered in the region where the ultrathin film ITO 228 is formed, and the region becomes the low-resistance region 227A, and the region with which the ultrathin film ITO 228 is not in contact remains in a high resistance, and thus becomes the high-resistance region 227B. As a result, a structure is obtained in which a resistance value is patterned in the plane. The low-resistance region 227A has a low resistance in both the plane direction and the film thickness direction of the oxide semiconductor layer. The high-resistance region 227B has a high resistance in the plane direction and may have a high resistance or a low resistance in the film thickness direction of the oxide semiconductor layer. The low-resistance region 227A preferably has a resistance of 1×10⁶Ω/□ or less in both the plane direction and the film thickness direction of the oxide semiconductor layer (the layered body including the hybrid layer 227 and the ultrathin film ITO 228). The high-resistance region 227B preferably has a resistance of more than 1×10⁶Ω/□ in the plane direction of the oxide semiconductor layer (hybrid layer 227).

When the pixel electrode is constituted only of the ultrathin film ITO 228 having a film thickness of 5 nm or less, the ultrathin film ITO 228 is broken at a contact hole, a terminal portion, and the like, resulting in poor connection, but by being layered with the hybrid layer 227 (high-resistance ITO), electrical connection is facilitated to be maintained by the high-resistance ITO, and an effect of preventing poor connection is obtained.

The ultrathin film ITO 228 may be layered on an upper layer of the hybrid layer 227 as illustrated in FIGS. 11A and 11B, or may be layered on a lower layer of the hybrid layer 227 as illustrated in FIGS. 12A and 12B.

When the ultrathin film ITO 228, which is pure with a small SiO impurity, is formed on the lower layer side, the ultrathin film ITO 228 serves as a seed (seed of crystalline growth), and thus, in the ITO on the upper portion thereof, purer and larger crystalline grains are likely to grow as compared with a portion without the ultrathin film ITO 228, and an effect of more easily reducing the resistance value inside the crystals (a resistance reduction effect in terms of crystalline growth) can also be expected. Thus, the ultrathin film ITO 228 is preferably provided on the lower layer of the high-resistance ITO.

In the present embodiment, IZO or AZO can be used instead of ITO.

### Seventh Embodiment

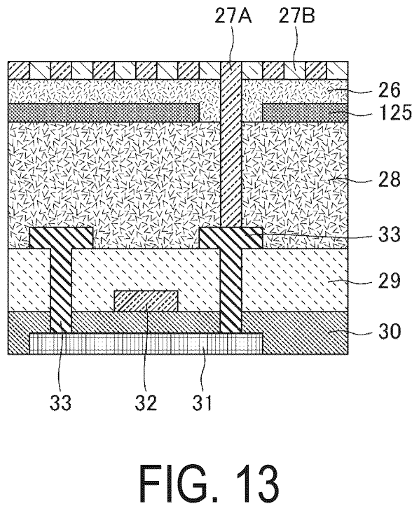

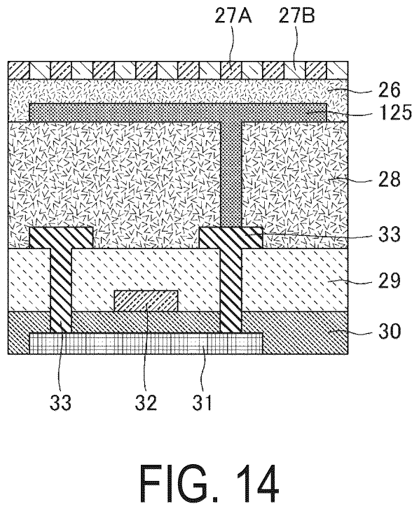

A seventh embodiment describes a connection form between the TFT and the electrode in the second substrate. FIG. 13 is a cross-sectional view schematically illustrating an example of a configuration of the second substrate of a liquid crystal element of the seventh embodiment, and FIG. 14 is a cross-sectional view schematically illustrating another example of the configuration of the second substrate of the liquid crystal element according to the seventh embodiment. The liquid crystal element of the seventh embodiment is an active matrix liquid crystal element including a TFT, and the second substrate is the FFS mode substrate including the TFT.

A layer (hierarchical layer) in which a slit electrode (electrode in which the plurality of FFS mode electrode slits are formed) is provided is constituted of the oxide semiconductor layer made of IGZO. The region (the low-resistance region 27A) where a part of the oxide semiconductor layer is made conductive functions as an electrode main body (the outer peripheral portion and the line-shaped electrode) of the slit electrode, and the region (the high-resistance region 27B) not being made conductive functions as the electrode slit of the slit electrode described above.

A solid electrode 125 is provided on the lower layer of the oxide semiconductor layer with the interlayer insulating film 26 interposed therebetween. A first insulating film 28, a second insulating film 29, a gate insulating film 30, and a low-temperature polysilicon (LPTS) layer 31 are provided in this order on the lower layer of the solid electrode 125. A gate electrode 32 (gate of the TFT) is disposed between the second insulating film 29 and the gate insulating film 30 at a position facing the low-temperature polysilicon (LPTS) layer 31. A source electrode layer 33 (source and drain of the TFT) is disposed between the first insulating film 28 and the second insulating film 29. The TFT is constituted by a low-temperature polysilicon (LPTS) layer 31, a gate electrode 32, and a source electrode layer 33.

The FFS mode substrate may have a configuration in which the solid electrode 125 provided in the lower layer functions as the common electrode and the slit electrode provided in the upper layer functions as the pixel electrode (see FIG. 13), or may have a configuration in which the solid electrode 125 provided in the lower layer functions as the pixel electrode and the slit electrode provided in the upper layer functions as the common electrode (see FIG. 14). When the slit electrode provided in the upper layer functions as the pixel electrode, the low-resistance region 27A that is the pixel electrode is electrically connected to a drain of the TFT through a contact hole formed in the interlayer insulating film 26 and the first insulating film 28 (see FIG. 13). On the other hand, when the solid electrode 125 provided in the lower layer functions as the pixel electrode, the solid electrode 125 that is the pixel electrode is electrically connected to the drain of the TFT through a contact hole formed in the first insulating film 28 (see FIG. 14).

The liquid crystal element of the seventh embodiment may be combined with an in-cell touch panel technology.

### Eighth Embodiment

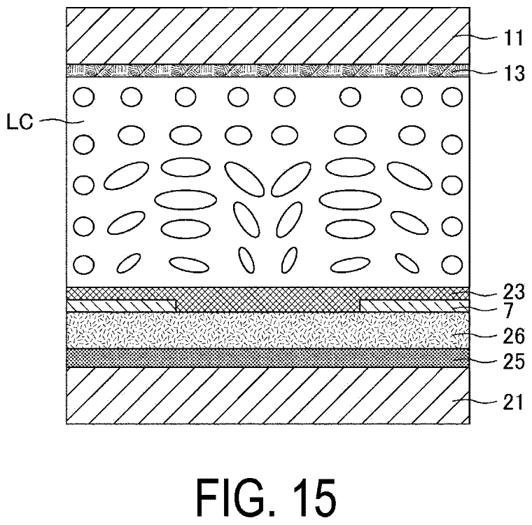

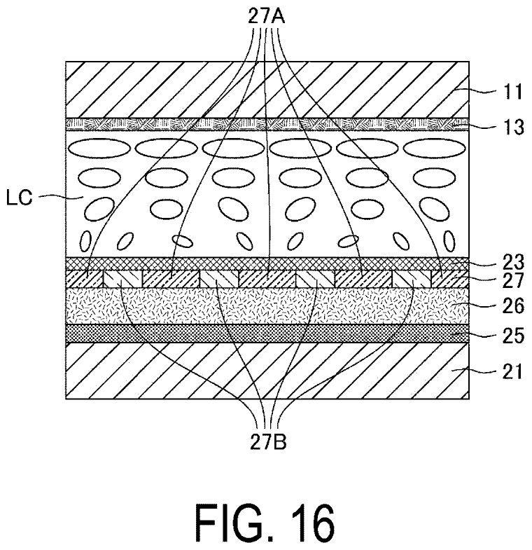

An eighth embodiment describes a liquid crystal alignment in the liquid crystal element. FIG. 15 is a cross-sectional view schematically illustrating an example of the liquid crystal alignment in a normal FFS mode liquid crystal element and FIG. 16 is a cross-sectional view schematically illustrating a liquid crystal alignment in a liquid crystal element of the eighth embodiment.

The liquid crystal element of the eighth embodiment is the same as the first embodiment except that a weak anchoring alignment film is adopted for at least one of the alignment films 13 and 23. In the disclosure, the “weak anchoring alignment film” means an alignment film having a weak alignment regulating force in the plane (in the horizontal plane) of the alignment film, and may be an alignment film (in this case, also referred to as a “zero anchoring alignment film”) having no alignment regulating force. Examples of the weak anchoring alignment film include a polymer brush as described in JP 2014-215421 A and a film using a weak anchoring liquid crystal alignment material (for example, PMMA) as described in WO 2022/030602 and WO 2023/140322.

In the liquid crystal mode of the transverse electrical field, the alignment of the liquid crystal molecules (liquid crystal alignment) is periodic when a voltage is applied, and thus diffraction corresponding to a pitch (that is, the length of one period) of the liquid crystal alignment may occur. As illustrated in FIG. 16, when the weak anchoring alignment film (zero anchoring alignment film) is used for at least one of the alignment films 13 and 23, the periodic alignment of the liquid crystal can be relaxed (made uniform), and thus diffraction can be suppressed. That is, according to the liquid crystal element of the eighth embodiment, diffraction derived from the electrode structure can be suppressed, and in addition, diffraction derived from the liquid crystal alignment can also be suppressed by the weak anchoring alignment film, and thus, a liquid crystal element having further high contrast and a high quality can be achieved.

Other Supplementary Notes A threshold voltage of the high-resistance region (first region) of the oxide semiconductor layer 27 may be formed so as to be higher than a drive voltage (a voltage for driving the liquid crystal layer, and also referred to as a liquid crystal drive voltage) of the liquid crystal layer. For example, the threshold voltage of the high-resistance region of the oxide semiconductor layer 27 may be 5 V and the liquid crystal drive voltage may be 3 V. When the threshold voltage of the high-resistance region of the oxide semiconductor layer 27 is designed to be higher than the liquid crystal drive voltage, the channel is not opened by the liquid crystal drive voltage, and thus the high-resistance region of the oxide semiconductor layer 27 is not made conductive. Thus, the liquid crystal element having high operation reliability can be obtained. The threshold voltage of the high-resistance region of the oxide semiconductor layer 27 can be adjusted by an injection amount of ions when performing the ion injection, an oxygen concentration in the oxide semiconductor, the thickness of the oxide semiconductor layer, the thickness of the interlayer insulating film, and the like.

The threshold voltage of the high-resistance region of the oxide semiconductor layer is measured by, for example, the following method.

A current (corresponding to a drain current) is measured when an electrical field is applied between a source (for example, one end of the high-resistance region 27B) of the high-resistance region 27B of the oxide semiconductor layer 27 and a drain (for example, the other end of the high-resistance region 27B) of the high-resistance region 27B while a voltage (corresponding to a gate voltage) applied to the common electrode 25 is changed. The gate voltage at which the drain current starts to abruptly flow is the threshold voltage of the high-resistance region 27B.

As the voltage applied to the common electrode 25 (second electrode) is increased, the resistance value of the high-resistance region of the oxide semiconductor layer 27 is significantly decreased from a certain voltage range. The certain voltage range is larger than the liquid crystal drive voltage. The resistance value of the high-resistance region when the liquid crystal drive voltage is applied to the common electrode 25 (second electrode) is larger than 1×10⁶ Ω/□.

### Examples and Comparative Examples

The effects of the disclosure will be described below with reference to the examples and comparative examples, but the disclosure is not limited by these examples.

### Example 1

The liquid crystal element of Example 1 is obtained by actually preparing the liquid crystal element of the first embodiment by the process performed in the order of the above steps (1) to (7), attaching a first polarizer to one surface of the liquid crystal element, and attaching a second polarizer to the other surface.

As a result of observing the point light source through the prepared liquid crystal element, it was confirmed that diffraction did not occur.

The prepared liquid crystal element was placed on a backlight, and the oblique contrast at the azimuth of 450 and the polar angle of 60° was evaluated. For the oblique contrast evaluation, “Ez-contrast” manufactured by ELDIM was used, and the oblique contrast was calculated by (transmittance when a white voltage was applied)÷(transmittance when a black voltage was applied). As a result, the oblique contrast of the liquid crystal element of Example 1 was 600.

For the liquid crystal element of Example 1, the sheet resistance of the films (oxide semiconductor layer) before and after the conductorization treatment was also evaluated.

The film before the conductorization treatment was evaluated using “Hiresta-UP MCP-HT450” manufactured by Mitsubishi Chemical Corporation, and the film after the conductorization treatment was evaluated using “Loresta-GP MCP-T610” manufactured by Mitsubishi Chemical Corporation. As a result, the sheet resistance of the film (corresponding to the high-resistance region) before the conductorization treatment was 2×10¹²Ω/□, and the sheet resistance of the film (corresponding to the low-resistance region) after the conductorization treatment was 7×10³Ω/□.

### Comparative Example 1

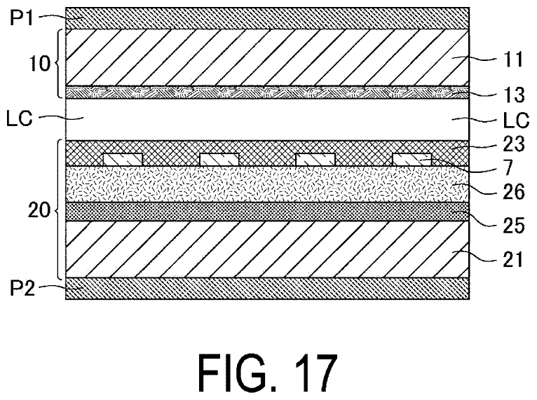

FIG. 17 is a schematic cross-sectional view illustrating a configuration of a liquid crystal element according to Comparative Example 1. The liquid crystal element of Comparative Example 1 is obtained by preparing a known FFS mode liquid crystal element, attaching a first polarizer P1 to one surface of the liquid crystal element, and attaching a second polarizer P2 to the other surface. In Comparative Example 1, an ITO layer was formed as the oxide semiconductor layer instead of the IGZO layer of Example 1. The ITO layer was patterned by a general process. That is, the FFS mode electrode 7 made of ITO was formed by a process of ITO deposition, positive resist formation, patterning with photolithography (exposure and development) of the positive resist, patterning of the ITO layer by dry etching, and resist peeling.

As a result of observing the point light source through the prepared liquid crystal element, diffraction occurred.

In addition, the prepared liquid crystal element was placed on the backlight, and the oblique contrast at the azimuth of 45 degrees and the polar angle of 60 degrees was evaluated, and as a result, the oblique contrast of the liquid crystal element of Comparative Example 1 was 300.

### Example 2

The liquid crystal element of Example 2 is obtained by actually preparing the liquid crystal element of the second embodiment, attaching the first polarizer to one surface of the liquid crystal element, and attaching the second polarizer to the other surface.

As a result of observing the point light source through the prepared liquid crystal element, diffraction was not visually recognized.

In addition, the prepared liquid crystal element was placed on the backlight, and the oblique contrast at the azimuth of 45 degrees and the polar angle of 60 degrees was evaluated, and as a result, the oblique contrast of the liquid crystal element of Example 2 was 560.

### Example 3

The liquid crystal element of Example 3 is obtained by actually preparing the liquid crystal element of the third embodiment, attaching the first polarizer to one surface of the liquid crystal element, and attaching the second polarizer to the other surface.

As a result of observing the point light source through the prepared liquid crystal element, diffraction was not visually recognized.

In addition, the prepared liquid crystal element was placed on the backlight, and the oblique contrast at the azimuth of 45 degrees and the polar angle of 60 degrees was evaluated, and as a result, the oblique contrast of the liquid crystal element of Example 3 was 580.

### Example 4

The liquid crystal element of Example 4 is obtained by actually preparing the liquid crystal element of the fourth embodiment, attaching the first polarizer to one surface of the liquid crystal element, and attaching the second polarizer to the other surface.

As a result of observing the point light source through the prepared liquid crystal element, diffraction was not visually recognized.

In addition, the prepared liquid crystal element was placed on the backlight, and the oblique contrast at the azimuth of 45 degrees and the polar angle of 60 degrees was evaluated, and as a result, the oblique contrast of the liquid crystal element of Example 4 was 620.

### Example 5

The liquid crystal element of Example 5 is obtained by actually preparing the liquid crystal element of the fifth embodiment, attaching the first polarizer to one surface of the liquid crystal element, and attaching the second polarizer to the other surface.

As a result of observing the point light source through the prepared liquid crystal element, diffraction was not visually recognized.

In addition, the prepared liquid crystal element was placed on the backlight, and the oblique contrast at the azimuth of 45 degrees and the polar angle of 60 degrees was evaluated, and as a result, the oblique contrast of the liquid crystal element of Example 5 was 610.

### Example 6

The liquid crystal element of Example 6 is obtained by actually preparing the liquid crystal element of the sixth embodiment, attaching the first polarizer to one surface of the liquid crystal element, and attaching the second polarizer to the other surface.

As a result of observing the point light source through the prepared liquid crystal element, diffraction was not visually recognized.

In addition, the prepared liquid crystal element was placed on the backlight, and the oblique contrast at the azimuth of 45 degrees and the polar angle of 60 degrees was evaluated, and as a result, the oblique contrast of the liquid crystal element of Example 6 was 550.

### Example 7

The liquid crystal element of Example 7 is obtained by preparing the liquid crystal element of the seventh embodiment, attaching the first polarizer to one surface of the liquid crystal element, and attaching the second polarizer to the other surface. The FFS mode substrate adopted a configuration in which the solid electrode provided in the lower layer functions as the common electrode and the slit electrode provided in the upper layer functions as the pixel electrode (see FIG. 13).

As a result of observing the point light source through the prepared liquid crystal element, diffraction was not visually recognized.

In addition, the prepared liquid crystal element was placed on the backlight, and the oblique contrast at the azimuth of 45 degrees and the polar angle of 60 degrees was evaluated, and as a result, the oblique contrast of the liquid crystal element of Example 7 was 530.

### Example 8

The liquid crystal element of Example 8 is obtained by actually preparing the liquid crystal element of the eighth embodiment, attaching the first polarizer to one surface of the liquid crystal element, and attaching the second polarizer to the other surface.

As the weak anchoring alignment film, a polymer having a structure represented by the following formula was used.

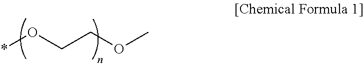

Note that * represents a bonding position, and n is 14.

As a result of observing the point light source through the prepared liquid crystal element, diffraction was not visually recognized.

In addition, the prepared liquid crystal element was placed on the backlight, and the oblique contrast at the azimuth of 45 degrees and the polar angle of 60 degrees was evaluated, and as a result, the oblique contrast of the liquid crystal element of Example 8 was 620.

The results of Examples 1 to 8 and Comparative Example 1 are collectively shown in the following Table 1.

TABLE 1

| | | | | Sheet | | |
|---|---|---|---|---|---|---|
| | Liquid | | | resistance of | | |
| | crystal | Oxide | Conductorization | conductive | Diffraction | Oblique |
| | mode | semiconductor | treatment | region | of light | CR |
| COMPARATIVE | FFS | Not used | — | 80 Ω/□ | Yes | 300 |
| EXAMPLE 1 | | | | | | |
| EXAMPLE 1 | FFS | IGZO | Ion doping | 7 × 10³ | None | 600 |
| | | | | Ω/□ | | |
| EXAMPLE 2 | IPS | IGZO | Ion doping | 7 × 10³ | None | 560 |
| | | | | Ω/□ | | |
| EXAMPLE 3 | FFS | IGZO | Plasma | 3 × 10² | None | 580 |
| | | | treatment | Ω/□ | | |
| EXAMPLE 4 | FFS | IGZO | SiNx | 1 × 10³ | None | 620 |
| | | | contact | Ω/□ | | |
| Example 5 | FFS | IGZO | Ultrathin | 1 × 10³ | None | 610 |
| | | | film SiNx | Ω/□ | | |
| | | | contact | | | |
| Example 6 | FFS | High- | Ultrathin | 1 × 10³ | None | 550 |
| | | resistance | film ITO | Ω/□ | | |
| | | ITO | contact | | | |
| Example 7 | FFS | IGZO | Ion doping | 7 × 10³ | None | 530 |
| | | | | Ω/□ | | |
| Example 8 | FFS | IGZO | Ion doping | 7 × 10³ | None | 620 |
| | | | | Ω/□ | | |

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal element comprising:
a first substrate;
a liquid crystal layer including liquid crystal molecules; and
a second substrate provided with a first electrode and a second electrode configured to apply a transverse electrical field to the liquid crystal layer,
wherein the second substrate includes an oxide semiconductor layer,
the oxide semiconductor layer includes, in a plane,
a first region and
a second region having a resistance in a plane direction of the oxide semiconductor layer smaller than a resistance of the first region,
the second region constitutes the first electrode, and
the first region constitutes an electrode slit.

2. The liquid crystal element according to claim 1,
wherein the second region further constitutes the second electrode.

3. The liquid crystal element according to claim 1,
wherein the second region is an ion doping region of the oxide semiconductor layer.

4. The liquid crystal element according to claim 1,
wherein the second region is a plasma treatment region of the oxide semiconductor layer.

5. The liquid crystal element according to claim 1,
wherein the second region is a reduction treatment region of the oxide semiconductor layer.

6. The liquid crystal element according to claim 1,
wherein the first electrode is constituted of a single layer of the oxide semiconductor layer.

7. The liquid crystal element according to claim 1, further comprising:
a SiNx layer or a SiNO layer thinner than the oxide semiconductor layer, on the second region of the oxide semiconductor layer.

8. The liquid crystal element according to claim 1,
wherein the oxide semiconductor layer includes IGZO, ITZO, IGO, or ITZGO.

9. The liquid crystal element according to claim 1,
wherein the oxide semiconductor layer includes a hybrid layer including a first oxide semiconductor and SiO₂ in the first region, and
the oxide semiconductor layer includes the hybrid layer and a first oxide semiconductor layer in the second region, the first oxide semiconductor layer is thinner than the hybrid layer and includes the first oxide semiconductor with a higher purity than the hybrid layer, and
the first oxide semiconductor is ITO, IZO, or AZO.

10. The liquid crystal element according to claim 1,
wherein the first region has a resistance of more than 1×10⁶Ω/□ in a plane direction of the oxide semiconductor layer, and
the second region has a resistance of 1×10⁶Ω/□ or less in both the plane direction and a film thickness direction of the oxide semiconductor layer.

11. The liquid crystal element according to claim 1,
wherein a threshold voltage of the first region of the oxide semiconductor layer is higher than a drive voltage of the liquid crystal layer.
